(19) United States
(12) Patent Application Publication
(10) Pub. No.: US 2013/0116804 A1
(43) Pub. Date: May 9, 2013

(54) METHOD FOR AUTOMATICALLY TRANSFERRING A CONFIGURATION OF AN AUTOMATION DEVICE DURING REPLACEMENT OF AN AUTOMATION DEVICE

(71) Applicant: Johannes Extra, Erlangen (DE)

(72) Inventor: Johannes Extra, Erlangen (DE)

(21) Appl. No.: 13/672,143

(22) Filed: Nov. 8, 2012

(30) Foreign Application Priority Data
Nov. 9, 2011 (EP) 11188357.5

(51) Int. Cl. G05B 13/02

(52) U.S. Cl. CPC G05B 13/02
USPC 700/82

(57) ABSTRACT

A method for automatically adopting a configuration of a first automation device on a second automation device includes storing on a removable storage medium a configuration and a unique identifier identifying the first automation device, comparing in the second automation device the stored unique identifier of the first automation device with a corresponding identifier of the second automation device, determining based on the difference between the stored unique identifier and the corresponding identifier of the second automation device whether the storage medium was previously used in a different automation device, and adopting the configuration of the first automation device on the second automation device.

### CROSS-REFERENCES TO RELATED APPLICATIONS

This application claims the priority of European Patent Application, Serial No. EP 11 188 357, filed Nov. 9, 2011, pursuant to 35 U.S.C. 119(a)-(d), the content of which is incorporated herein by reference in its entirety as if fully set forth herein.

### BACKGROUND OF THE INVENTION

The present invention relates to a method for automatically adopting a configuration of a first automation device on a second automation device, for example when an automation device is replaced.

The following discussion of related art is provided to assist the reader in understanding the advantages of the invention, and is not to be construed as an admission that this related art is prior art to this invention.

The term “automation device” encompasses all devices, equipment or systems, i.e. in addition to e.g. controllers, such as programmable logic controllers, process control computers, (industrial) computers and the like, also drive controllers, frequency converters and the like, such as are or can be used for controlling, regulating and/or monitoring technical processes e.g. for transforming or transporting material, energy or information, etc., wherein energy is expended or converted in particular by way of suitable technical apparatus, such as e.g. sensors or actuators.

A need to replace a first automation device with a second automation device may arise when the functionality or performance of the first automation device is no longer adequate and a device capable of delivering increased performance is to be deployed as the second automation device. Other situations are the replacement of a defective automation device by an equivalent new automation device or the temporary replacement of a first automation device by an equivalent or at least in principle equivalent second automation device, e.g. when the first automation device has to be taken out of service for a short time on account of maintenance activities.

In such a replacement of a first automation device by a second automation device, the user removes a respective storage medium from the first automation device. At least one control program and/or control program data for a technical process or subprocess that is to be controlled and/or monitored in each case are stored on the storage medium. The storage medium is thereupon combined with the second automation device, e.g. by being inserted into a slot for a storage medium, and as a result the second automation device gains access to the control program which is stored on the storage medium and which was previously executed by the first automation device.

A disadvantageous aspect with this approach, however, is that after the first activation of the second automation device or in connection with the first activation of the second automation device it is necessary to perform an initialization, parameterization and the like of the hardware and/or software functional units encompassed by the second automation device.

A manual intervention by the user was necessary for this in the prior art. In such cases, e.g. following the first activation of the second automation device, the user triggers a corresponding functionality in order to initialize e.g. software modules in the second automation device. For the initialization, the user makes use of input media possibly provided by the second automation device itself, such as e.g. switches and the like, or a corresponding functionality in an engineering system which is implemented e.g. on a programming device or the like which is communicatively connected to the second automation device, with the result that a possibility of accessing a configuration of the second automation device is provided by means of the engineering system. Such a manual configuration is laborious and time-consuming, can in some cases only be carried out by specialist personnel, and is prone to error.

It would therefore be desirable and advantageous to obviate prior art shortcomings and to provide an improved method for automatically adopting a configuration of a first automation device on a second automation device, wherein the method can be executed automatically and thus requires no or only minimal actions on the part of the user, and in particular is less susceptible to error.

### SUMMARY OF THE INVENTION

According to one aspect of the present invention, a method for automatically adopting a configuration of a first automation device on a second automation device includes the steps of storing with the first automation device on a removable storage medium a configuration and a unique identifier identifying the first automation device, reading with the second automation device from the storage medium the stored unique identifier and comparing in the second automation device the stored unique identifier of the first automation device with a corresponding identifier of the second automation device, detecting with the second automation device a difference between the stored unique identifier and the corresponding identifier of the second automation device, determining based on the difference whether the storage medium was previously used in a different automation device, and adopting on the second automation device the configuration of the first automation device stored on the storage medium as a configuration of the second automation device.

According to an advantageous feature of the present invention, the respective configuration of an automation device is also at least provided on the removable storage medium. When the storage medium is removed from the first automation device and subsequently combined with the second automation device, the configuration can be transferred to the second automation device. The term “configuration” means in the present context and hereinafter, individually or in combination, all of the data of the automation device which determines the scope of its functionality or other settings or the like. A configuration, within the meaning outlined above, is thus e.g. a network address by which an automation device can be addressed in a communications network, and/or one or more possibly retroactively loaded functionalities of an automation device which do not belong to the normal functional scope of the automation device, and/or data from or for the respective technical process, at least insofar as it cannot be read out directly from the technical process, such as e.g. closed-loop control parameters and the like, and so forth. Depending on application scenario, the term “configuration” can include additional data which normally must not be lost when a first automation device is replaced by a second automation device or which formerly when a first automation device was replaced by a second automation device had to be input manually by the user on the new, second automation device.

In addition to its respective configuration, the first automation device also stores a unique identifier characterizing the automation device on the removable storage medium, such that it is recognizable, when the same storage medium is used in a different automation device, i.e. the second automation device, which replaces the first automation device e.g. in a fault situation, on the part of such a second automation device that a configuration of the first automation device is contained on the storage medium. Because the second automation device reads out the identifier and compares the same with its own identifier and, if the stored identifier differs from its own identifier, recognizes that the storage medium was previously used in a different automation device and thereupon adopts the configuration stored on the storage medium as its own configuration, the necessary configuration for the second automation device is transferred more or less automatically and without, or with only minimal, intervention on the part of the respective user. Errors in transferring the configuration, such as could occur repeatedly with the former manual configuration of a second automation device using copied or otherwise acquired configuration data of the first automation device, can thus be effectively avoided. Moreover, the automatic transfer of the configuration is considerably faster than was possible previously. Finally, with the automatic transfer of the configuration stored on the storage medium as the new, device-specific configuration for a second automation device which replaces a first automation device, it is ensured that the configuration of the first automation device is transferred not only correctly, but also completely.

According to an advantageous feature of the present invention, the configuration which is stored on the storage medium and may be taken over by the second automation device may include firmware of the first automation device as well as parameterization data of the first automation device. Firmware refers, as is well known, both to operating software of various devices and to the underlying software of a computer, for in this regard an automation device is nothing other than a specialized computer. The firmware acts e.g. as interface between the hardware of the respective automation device and a runtime environment, in other words e.g. an operating system, and a control program. In this way the firmware can determine the functional scope of individual units of the automation device and the respective functional unit (software functional unit and/or hardware functional unit) configured up to that point is then available to the control program. Because the configuration includes not only such firmware but also parameterization data of the first automation device, all the variable data describing the status and/or the functional scope of the first automation device is stored on the removable storage medium and can thereby be taken over by the second automation device when the storage medium is combined with the second automation device.

According to another advantageous feature of the present invention, the parameterization data of the first automation device may also include parameterization data for all peripheral devices or at least for selected peripheral devices of the first automation device. The parameterization data may include, for example, parameterization data for modules which are combined with or at least communicatively connected to the first automation device, such as, for example, controller modules, communication modules, operator contra units, such as, for example, operator panels, etc. The transfer of such a configuration of the first automation device, which therefore includes parameterization data of the first automation device on the one hand, but on the other hand also parameterization data of peripheral devices of the first automation device, consequently permits the even more extensive transfer of the configuration of the first automation device and enables a second automation device, in a situation in which the latter is intended to replace the first automation device, to be placed seamlessly into operation. This is particularly advantageous for modular automation systems, such as e.g. programmable logic controllers or the like, in which, in the event of a possible failure or a maintenance situation of a first automation device, only a central processing unit or the like must be replaced by a new central processing unit. In such a scenario the term “automation device” used consistently throughout this description refers in each case to a module or a functional unit of such an automation system.

According to another advantageous feature of the present invention, the unique identifier may include an identification of a processor incorporated in the respective automation device and/or an identification characterizing a hardware component of the automation device or is formed on the basis thereof. A suitable identification of a hardware component of the automation device may be, for example, so-called MAC address or the like of a communication module or of a corresponding functional unit. Alternatively or in addition, for example a serial number or the like of the automation device the identifier may be read out. The aforementioned examples for generating a unique identifier are only exemplary and in no way exhaustive. The use of such an identifier normally guarantees an implicit uniqueness of the identifier, with the result that no further measures are necessary in respect of the usability of the identifier. Furthermore, normally such values can simply be read out in the respective automation device and an identifier created therewith or on the basis thereof can be easily realized, e.g. in the form of a greater-than-or-less-than comparison or in the form of a comparison of two character strings.

According to another advantageous feature of the present invention, the second automation device may store an identifier of its own on the removable storage medium after having taken over the configuration stored on the removable storage medium. This ensures that in the event of a possible failure or when the second automation device must be replaced, i.e. when the storage medium must also be removed from the second automation device and subsequently combined with a new, third automation device, or with the first automation device, when the first automation device becomes available again, e.g. following a repair, it is immediately recognizable that the storage medium has been used in the interim by the second automation device. Another possibility for specifying a point in time at which the respective automation device stores its identifier on the storage medium is that point in time at which the configuration—in the above-described sense—of the second automation device is changed for the first time, e.g. as a result of a user intervention or on account of a change in status of the technical process. In that event the second automation device must at least copy its configuration onto the storage medium, if this configuration is not already available only on the storage medium. With the change thus being made in the configuration previously stored on the storage medium, the identifier of the second automation device is likewise stored on the storage medium, such that it can be recognized which automation device left the changed configuration on the storage medium. A point in time at which the respective automation device stores its identifier on the storage medium may also be based on an impending replacement being signaled to the respective automation device and the automation device thereupon storing its configuration and a unique identifier on the storage medium. This is particularly simple to implement as a functionality of the automation device because e.g. it is only necessary to monitor the setting of a switching element by means of which a forthcoming replacement can be signaled. However, this solution cannot be used if an automation device fails and this constitutes the necessity of the replacement, because the failure of an automation device may potentially also reach such an extent that it is no longer possible to monitor such a switching element and/or to transfer data from the automation device to the storage medium.

According to another aspect of the invention, an automation device for controlling and/or monitoring a technical process includes a processor, for example a microprocessor, and a memory into which a computer program stored on a non-transitory storage medium is loaded, wherein the computer program has program instructions which, when executed by the processor during operation of the automation device, cause the automation device to read from a removable storage medium a stored unique identifier associated with another automation device, compare the stored unique identifier of the other automation device with a corresponding identifier of the automation device, determine based on a detected difference between the stored unique identifier of the other automation device and the corresponding identifier of the automation device whether the removable storage medium was previously used in another automation device, and adopt the configuration of the other automation device stored on the storage medium as a configuration of the automation device.

The invention may be implemented in software, for example in form a computer program comprising program code instructions which can be executed on a computer. The computer program and/or program code instructions may be stored on a non-volatile storage medium.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows an automation device in a networked arrangement with other automation devices,

FIG. 2 shows details of an automation device according to the present invention, and

FIG. 3 is a flowchart of a computer program which is executable by the automation device.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

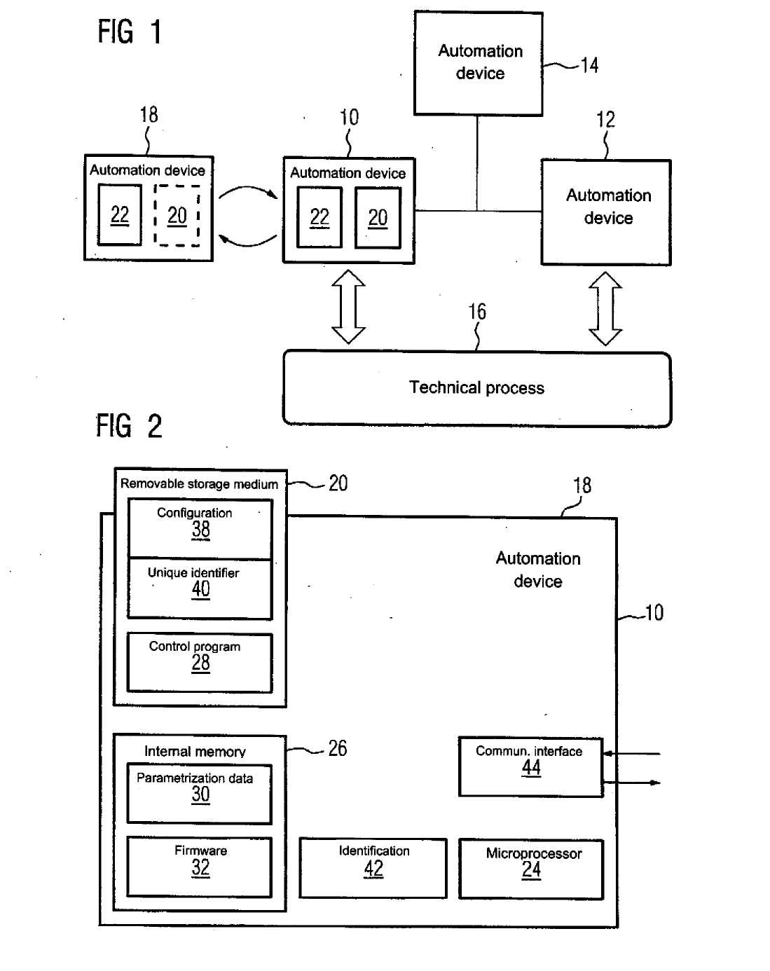

Turning now to the drawing, and in particular to FIG. 1, there is shown a simplified schematic diagram of an automation device 10, such as is provided—where appropriate, in a networked arrangement with other identical or similar automation devices 12, 14—for controlling and/or monitoring a technical process 16. In the event that it becomes necessary to replace the automation device 10, which, by way of differentiation, is referred to hereinafter as the first automation device 10, with another automation device 18, which, likewise by way of differentiation, is referred to hereinafter as the second automation device 18, it is provided that the first automation device 10 stores its configuration and a unique identifier 22 characterizing the first automation device 10 on a removable storage medium 20. It is furthermore provided that when the storage medium 20 is combined with the second automation device 18, the latter reads out the identifier 22 of the first automation device 10 stored on the storage medium 20 and compares the same with a corresponding identifier 22 of its own. It is recognizable for the second automation device 18, on the basis of a deviation of the stored identifier 22 from its own identifier 22, that the storage medium 20 was previously used in another automation device, namely the first automation device 10. The second automation device 18 can thereupon adopt the configuration stored on the storage medium 20 as its own configuration in order to be able to take over, immediately and seamlessly, the functionality previously provided by the first automation device 10, in other words, for example, to be directly reachable for further automation devices 12, 14 at the network address previously assigned to the first automation device 10.

FIG. 2 shows an automation device—likewise in a schematically greatly simplified view—to the extent that its layout and units encompassed thereby are relevant in connection with the description presented here. The description of such an automation device is valid in equal measure for the first automation device 10 and for the second automation device 18, but also in principle for any other automation device 12, 14 (FIG. 1).

Accordingly, such an automation device 10, 18 comprises a processing unit in the form or manner of a microprocessor 24 and then an internal memory 26. The removable storage medium 20, when combined with the automation device 10, 18, forms the latter's working memory in conjunction with the internal memory 26. A control program 28 which specifies how the respective automation device 10, 18 is involved in the control and/or monitoring of the technical process 16 (FIG. 1) is or can be loaded into the internal memory 26 and/or on the storage medium 20.

Parameterization data 30, in other words e.g. data for initialization values or current values of variables processed by the control program 28 and representing e.g. states of the respective technical process 16 or internal states of the control program 28, such as e.g. feedback control parameters, is also held available in the memory 26 and/or on the storage medium 20. Firmware 32, which provides or specifies additional functionalities of the automation device 10, 18 or defines their respective functional scope, is additionally contained in the memory 26 or—in special embodiment variants—in a separately accessible memory in the manner of an EPROM or flash memory.

The removable storage medium 20 can be combined with the automation device 10, 18 and data stored or storable thereon is available in that an access in a form similar to an access to the internal memory 26 takes place. The respective automation device 10, 18 stores its configuration 38 and a unique identifier 40 characterizing the respective automation device 10, 18 on the removable storage medium 20.

Individual parts of the parameterization data 30 or all of the parameterization data 30 and the firmware 32 or parts of the firmware 32, for example, come into consideration as the configuration 38. Suitable as identifier 40 is e.g. an identifier of the processor 24 encompassed in each case by the automation device 10, 18 and/or a hardware address, e.g. a MAC address. An identification 42 is shown symbolically as a basis for such an identifier 40 in the diagram in FIG. 2. The identification 42 is shown without a direct reference to the processor 24, because it may not necessarily refer back to the processor 24, but may e.g. also link back to a communication interface 44 for exchanging data with other automation devices 12, 14 (FIG. 1) or other units of the respective automation device 10, 18. It should also be taken into consideration that the graphical representation shown in FIG. 2 makes a distinction between the identifier 40 on the storage medium 20 and the identification 42. If, however, the identification 42 is stored as identifier 40 on the storage medium 20, then identifier 40 and identification 42 are identical or the identifier 40 is at least based on the identifier. In certain contexts, therefore, the terms identifier 40 and identification 42 are synonymous. It is also not necessary to use a possible identification of a processor 24 or a corresponding identification of a communication interface 44 directly as identification 42, but instead the identification 42 can also be created on the basis of such identifying means in that e.g. only a certain number of places of an identification 42 present in the form of a character string are used.

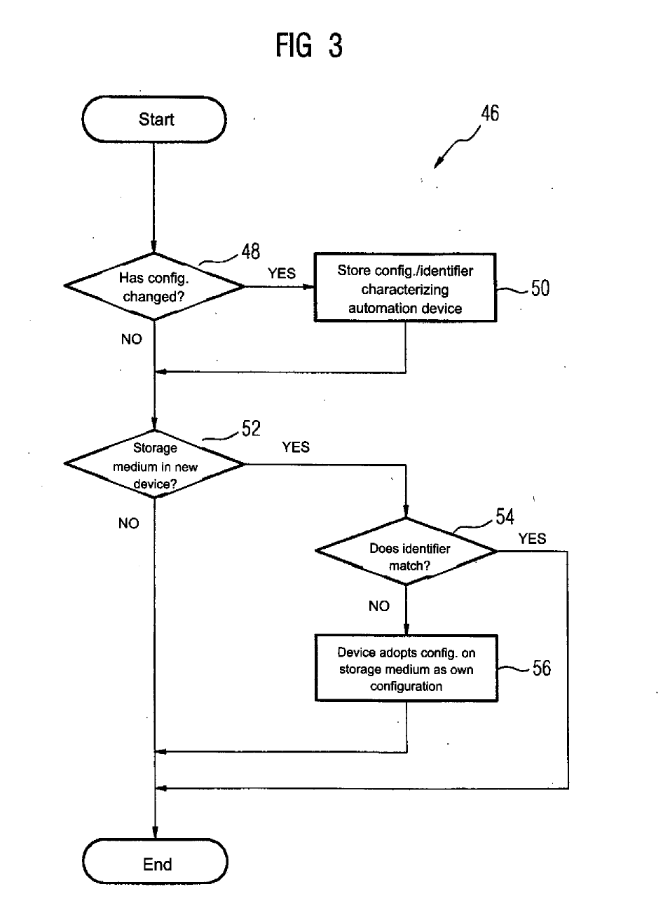

FIG. 3 shows a schematically simplified flowchart of a computer program 46 for implementing the method as described above and possibly of individual embodiments of the same. According thereto, at the latest when it has been established in a first step 48 or in some other suitable form and manner or it has transpired that a configuration of the automation device 10, 18 has changed, an automation device 10, 18 stores such a configuration 38 on the removable storage medium 20 and at least at the first time such an access to the storage medium 20 takes place stores an identifier 40 uniquely characterizing the automation device 10, 18 (second step 50). At the latest when it is recognizable for the respective automation device 10, 18 that a storage medium 20 has been newly combined with the device, e.g. by the storage medium having been inserted into a memory card slot provided by the automation device 10, 18 (third step 52), a check is then made (fourth step 54) to determine whether an identifier 40 stored on the storage medium 20 matches an identification 42 of the device's own. If this is the case, the respective storage medium 20 has already been used previously by the respective automation device 10, 18 and a return branch can be made to the normal execution sequence of the computer program 46. If, on the other hand, this is not the case, i.e. whenever a difference has been detected between the identifier 40 stored on the storage medium 20 and the device's own identification 42, it is evident that the storage medium 20 has previously been used in a different automation device 10, 18. In that event the configuration 38 stored on the storage medium 20 is taken over as the device's own configuration in a fifth step 56 and a branch is thereupon made to the normal execution sequence of the computer program 46.

It is irrelevant for the functionality of the computer program 46 in this case whether the first and the second step 48, 50 for storing a device's own identification 42 as identifier 40 on the storage medium 20 at the latest when changes to the device configuration take place on the respective automation device 10, 18, are placed before or after the third, fourth and fifth step 52, 54, 56, because e.g. in a cyclic execution of the computer program 46 having the component parts shown in FIG. 3 and possibly further component parts between the component parts shown, an execution of the second step 50 or of the fourth or fifth step 54, 56 only ever takes place when a corresponding condition, expressed by the first or third step 48, 52, is fulfilled.

The computer program 46 is normally held available in the memory 26 (FIG. 2) of the automation device 10, 18 and can e.g. be part of what is called runtime software (not shown) which typically is likewise stored in the memory 26.

Individual salient aspects of the description submitted here can accordingly be briefly summarized as follows: A method for automatically transferring a configuration of a first automation device 10 for a second automation device 18 is disclosed, wherein the first automation device 10 stores its configuration 38 and a unique identifier 40 on a removable storage medium 20, wherein when the storage medium 20 is combined with the second automation device 18 the latter reads out the identifier 40 stored on the storage medium 20 and compares the same with a corresponding identification 42 of its own, wherein the second automation device 18 recognizes on the basis of a possible deviation that the storage medium 20 was previously used in a different automation device 10 and thereupon takes over the configuration 38 stored on the storage medium 20 as its own configuration. Because the first automation device 10, or that automation device 10, 18 currently using the storage medium 20, stores a unique identifier 40 thereon, the respective automation device effectively “signs” the storage medium 20. Automation devices 10, 18 subsequently using the thus signed storage medium 20 recognize by the respective signature, i.e. the identifier 40 stored on the storage medium 20, whether the configuration 38 stored there possibly represents the configuration of a different automation device 10, 18, namely, for example, the configuration 38 of a predecessor automation device 10, 18 which is replaced by the automation device 10, 18 checking the identifier 40. If such a situation is detected, the stored configuration 38 can be taken over and the respective automation device 10, 18—referred to hereinabove in each case as the second automation device 18—can be placed into operation with the original configuration 38 of the first automation device 10, thereby producing a possibility of a fast, error-free and virtually seamless transition when a situation arises where it is necessary to replace a first automation device 10 by a second automation device 18.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A method for automatically adopting a configuration of a first automation device on a second automation device, comprising the steps of:
storing with the first automation device on a removable storage medium a configuration and a unique identifier identifying the first automation device;
reading with the second automation device from the storage medium the stored unique identifier and comparing in the second automation device the stored unique identifier of the first automation device with a corresponding identifier of the second automation device;
detecting with the second automation device a difference between the stored unique identifier and the corresponding identifier of the second automation device;
determining based on the difference whether the storage medium was previously used in a different automation device; and
adopting on the second automation device the configuration of the first automation device stored on the storage medium as a configuration of the second automation device.

2. The method of claim 1, wherein the configuration of the first automation device stored on the removable storage medium comprises firmware of the first automation device and parameterization data of the first automation device.

3. The method of claim 2, wherein the parameterization data of the first automation device also comprise parameterization data for peripheral device devices that are part of the first automation device and wherein adopting the configuration of the first automation device by the second automation device also includes adopting the parameterization data for peripheral device devices of the first automation device for peripheral device devices that are part of the second automation device.

4. The method of claim 1, wherein the unique identifier includes or is based on an identification of a processor that is part of the first automation device

5. The method of claim 1, wherein the unique identifier includes or is based on an identification characterizing a hardware component of the first automation device.

6. The method of claim 1, wherein the second automation device stores on the removable storage medium a specific identifier after adopting the configuration of the first automation device stored on the removable storage medium.

7. The method of claim 1, wherein an impending replacement is signaled to the first automation device which causes the first automation device to store on the removable storage medium the configuration and the unique identifier characterizing the first automation device.

8. A computer program stored on a non-transitory storage medium and comprising program code which when executed on an automation device for controlling and/or monitoring a technical process, causes the computer program to execute a method for automatically adopting a configuration of a first automation device on a second automation device, wherein the method comprises the steps of:
storing with the first automation device on a removable storage medium a configuration and a unique identifier identifying the first automation device,
reading with the second automation device from the storage medium the stored unique identifier and comparing in the second automation device the stored unique identifier of the first automation device with a corresponding identifier of the second automation device,
detecting with the second automation device a difference between the stored unique identifier and the corresponding identifier of the second automation device,
determining based on the difference whether the storage medium was previously used in a different automation device, and
adopting on the second automation device the configuration of the first automation device stored on the storage medium as a configuration of the second automation device.

9. An automation device for controlling and/or monitoring a technical process, comprising a processor and a memory into which is loaded a computer program stored on a non-transitory storage medium, wherein the computer program has program instructions which, when executed by the processor during operation of the automation device, cause the automation device to
read from a removable storage medium a stored unique identifier associated with another automation device,
compare the stored unique identifier of the other automation device with a corresponding identifier of the automation device,
determine based on a detected difference between the stored unique identifier of the other automation device and the corresponding identifier of the automation device whether the removable storage medium was previously used in another automation device, and
adopt the configuration of the other automation device stored on the storage medium as a configuration of the automation device.
